(19) United States
(12) Patent Application Publication
(10) Pub. No.: US 2010/0211557 A1
(43) Pub. Date: Aug. 19, 2010

(54) WEB SEARCH SYSTEM AND METHOD

(76) Inventor: Amit Gupta, Pittsford, NY (US)

Correspondence Address: Leason Ellis LLP, 81 Main Street, Suite 503, White Plains, NY, 10601, US

(21) Appl. No.: 12/593,858

(22) PCT Filed: Mar. 31, 2008
(86) PCT No.: PCT/GB08/01143

§ 371 Date: Mar. 24, 2010

(30) Foreign Application Priority Data
Mar. 30, 2007 (GB) 0706300.1

(51) Int. Cl. G06F 17/30

(52) U.S. Cl. 707/706; 707/E17.108

(57) ABSTRACT

A web search system, network, plug-in and method are disclosed. An interface having a primary non-web browsing function is arranged to accept entry of text. A control subsystem is triggerable on demand to submit at least a portion of said entered text to a predetermined web search engine, the search system being arranged to display results from the web search engine.

### FIELD OF THE INVENTION

This present invention relates to a web search system, network, method and plug-in that is particularly applicable to latency sensitive devices and devices with limited input capability such as mobile phones.

### BACKGROUND TO THE INVENTION

Mobile phones have a larger consumer penetration than Personal Computers. However, whilst Internet services are widely available for mobile phones, uptake of use of Internet services from mobile devices has been extremely poor. Larger scale devices such as laptops and desktop PCs still make up the majority of the devices used to access the internet. One particular problem with mobile devices such as mobile phones is that they suffer from a lack of display capability, processing capability, and input capability.

Email messaging, Instant Messaging, and Web search are the three most used services on the Internet today. In contrast, on the mobile phone the most frequently used application is the messaging application (SMS). Whilst web based search services are highly used on desktops and laptops, such services experience little or no use from mobile phones.

Currently, there are three main ways to do an internet search on a mobile device. The first involves the user sending a text message to a predefined phone number. This message is relayed from the short messaging service centre (SMSC) over the Internet or local network to an internet connected server that analyzes the query, performs the search and then responds with a text message via the SMSC with the results.

The second method is by use of a 3^{rd} party search application that focuses just on search. Penetration and usage of these applications has been limited due to consumer inertia and lack of a single source of “good” content. Most mobile relevant content is scattered throughout the web and hosted by many different sites.

The third method is using a basic web search. A basic web search does not differ when performed on a mobile device instead of a laptop or desktop. Three steps are generally performed by a user to retrieve their results (we will use google in our example here):

1) The user opens a web browser and types in the url (eg: http://www.google.com, www.google.com, google)
2) User waits for the main web page to load
3) The User inputs the search query and clicks submit
4) User Waits for search results to be displayed

On wireless data networks, there is an issue related to high latency of requests even if there is plenty of bandwidth available. This latency can be as much as 2 seconds to establish a connection. Along with latency issues, it is also generally slower and more cumbersome to input characters on a mobile phone than on a PC. Because of these issues, the traditional steps #1-4 mentioned above are not ideal for mobile users as it makes them type more characters (steps 1 and 3), and it exposes them to the latency delays multiple times (steps 2 and 4) while waiting for multiple web page downloads in multiple steps

### STATEMENT OF INVENTION

According to an aspect of the present invention, there is provided a web search system comprising an interface and a control subsystem, the interface having a primary non-web browsing function and being arranged to accept entry of text, wherein the control subsystem is triggerable on demand to submit at least a portion of said entered text to a predetermined web search engine, the search system being arranged to display results from the web search engine.

The web search system may further comprise a repository arranged to store text entries, the control subsystem being arranged to present suggested one of said text entries in dependence on said text entered.

The repository is preferably arranged to store web search terms associated with said text entries, the control subsystem being arranged to present suggested web search terms in dependence on said text entered.

The repository is preferably arranged to associate a predetermined web search engine with each web search term, wherein the control subsystem is arranged to submit said web search term to its associated web search engine upon being triggered.

The control subsystem is preferably arranged to update said repository from a remote source.

The primary non-web browsing function is preferably a short messaging service application.

The control subsystem may comprise a menu of predetermined web search engines or other interactive websites.

Preferably, the search system is integrated in, or provided as a plug-in to, a short messaging service application.

According to another aspect of the present invention, there is provided qa network as claimed in claim 8.

Preferably, each web search system is arranged to synchronise its stored predictive text entries with those of the management system.

Each web search system may be arranged to obtain updates to its stored predictive text entries from the management system.

Each of the web search systems preferably includes a database of predetermined web search engines, the management system being arranged to maintain a database of web search engines in the data repository and synchronise said repository with said web search systems.

The management system may be arranged to associate web search engines with said predictive text entries, wherein each of the web search systems is arranged to use said associated web search engine as the predetermined web search engine.

According to another aspect of the present invention, there is provided a plug-in as claimed in claim 13.

According to another aspect of the present invention, there is provided a method according to claim 14.

The method preferably further comprises storing text entries and presenting a suggested one of said text entries in dependence on said text entered.

The method preferably further comprises storing web search terms associated with said text entries and presenting suggested web search terms in dependence on said text entered.

The method preferably further comprises associating a predetermined web search engine with each web search term and submitting said web search term to its associated web search engine activation of the triggering step.

The control subsystem may comprise a menu of predetermined web search engines or other interactive websites. The control subsystem may comprise a predictive text system having a database of text entries, wherein one or more predetermined search engines or other interactive websites are associated with at least selected ones of the text entries, the control subsystem including means for presenting suggested text entries to a user in dependence on said text entered, wherein if the suggested text entry includes an associated predetermined search engine or other interactive website, the control subsystem being arranged to accept an input from said user to submit said entered text including said suggested text entry to the predetermined search engine or other interactive website.

The present invention seeks to provide an improved web search system and method that is particularly applicable to mobile devices and does not expose the user as significantly to latency issues. The present invention also seeks to provide a method and system in which alternate input means are provided to increase speed of use.

In particular, the present invention seeks to eliminate the first two steps discussed above by enhancing a messaging application to make search submission over the internet more efficient.

Optionally, a plurality of predetermined search websites or other interactive websites may be selectable via said control subsystem. The predetermined search websites and other interactive websites may be updated via a central server or database in dependence on user feedback or community based feedback.

The present invention seeks to avoid the need for an application to perform steps 1 and 2 discussed above by utilizing an enhanced messaging application to skip to step 3. In this method, the user opens their regular messaging application and types in their search query as if they were typing in a message. The user executes the query by using a regular menu option such as Options->Search, which then causes the messaging application to automatically submits the query to the search engine and displays the resulting web page. This eliminates the need to type in the search engine's URL (step 1), and it eliminates the need to wait for the Search engines initial page to load (step 2). This method gives users a much quicker method to accessing the search results than existing methods give.

### BRIEF DESCRIPTION OF THE DRAWINGS

Embodiments of the present invention will now be described, by way of example only, with reference to the accompanying drawings in which:

FIG. 1 is a schematic diagram illustrating operation of a web search system according to an embodiment of the present invention;

FIG. 2 is a schematic diagram of components of a platform suitable for operating the web search system of FIG. 1;

FIG. 3 is a schematic diagram of a web search system according to a further embodiment of the present invention; and,

FIG. 4a-c are screen shots illustrating aspects of the web search system of FIGS. 1-3 in operation.

### DETAILED DESCRIPTION

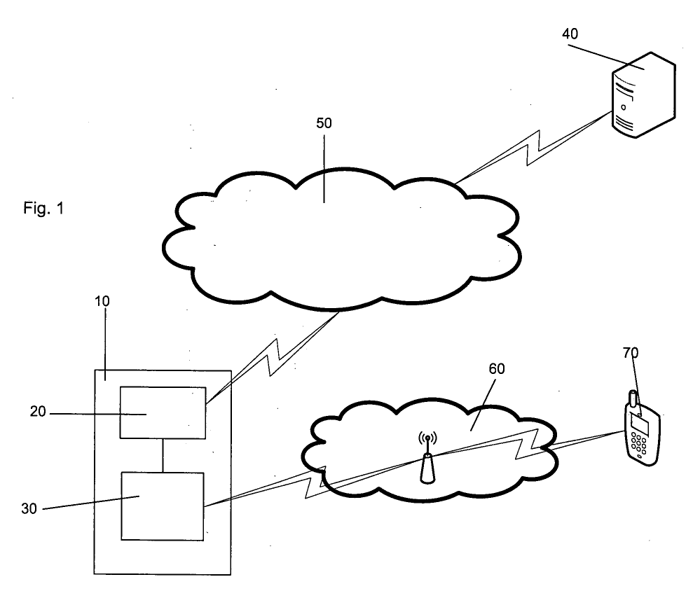

FIG. 1 is a schematic diagram illustrating operation of a web search system according to an embodiment of the present invention.

The web search system 10 includes an interface 20 and a control subsystem 30. The interface 20 has a primary non-web browsing function and is arranged to accept entry of text. The control subsystem 30 is triggerable on demand to submit at least a portion of the entered text to a predetermined web search engine 40 via the internet 50. The search system 10 is arranged to receive and display results from the web search engine 40.

Preferably, the primary non-web browsing function is short message service (SMS) that allows text messaging to a remote user device 70 via a mobile telephone network 60. The SMS function allows unconstrained text entry via the interface 20. Upon demand of the user, the control subsystem 30 can be triggered to submit a portion of the text to the web search engine 40.

The portion could be a single word, a sentence, all of the text or some user selected portion.

The control subsystem may include a menu of selectable web search engines or other interactive websites. The control subsystem may also include a predictive text system having a database of text entries, wherein one or more predetermined search engines or other interactive websites are associated with at least selected ones of the text entries. The control subsystem may include means for presenting suggested text entries to a user in dependence on said text entered. If the suggested text entry includes an associated predetermined search engine or other interactive website, the control subsystem would be arranged to accept an input from said user to submit said entered text including said suggested text entry to the predetermined search engine or other interactive website.

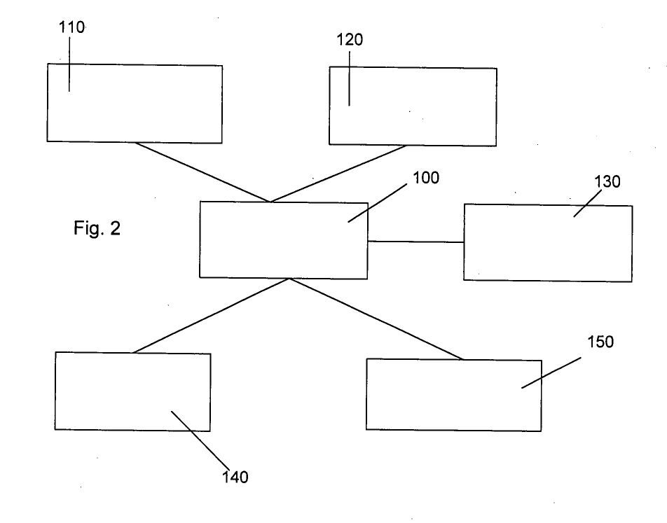

FIG. 2 is a schematic diagram of components of a platform suitable for operating the web search system of FIG. 1.

The system 10 includes a processor 100, an input output (I/O) system 110, a display 120, a repository 130, and first and second communication subsystems 140, 150.

The processor 100 operates the control subsystem 30 and also provides the interface 20 in conjunction with the I/O system 110 and display 120.

The first and second communication subsystems 140, 150 provide, respectively, network access to the internet and to a mobile telephone network.

The I/O system preferably includes a keypad or other text entry means.

The repository 130 may be local, remote or some combination of the two. Preferably, the repository includes a database of elements comprising commonly used words or terms for use with the primary non-web browsing function. Most preferably, the database is a dictionary used by a text prediction system. In preferred embodiments of the present invention, web search terms are stored in the repository 130 and associated with at least selected ones of the elements of the database.

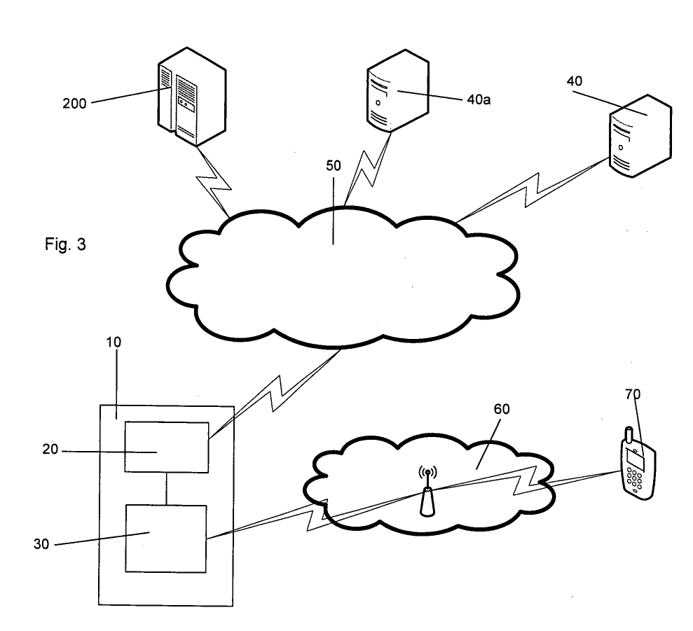

FIG. 3 is a schematic diagram of a web search system according to a further embodiment of the present invention.

In the illustrated embodiment, a further web search engine 40a is made available to the search system. The selection of web search engine (40 or 40a) could be made manually by the user (for example by selecting a different menu item) or it could be dependent on the term to be searched. Indeed, as well as storing search terms in the repository, associations with predetermined web search engines could also be stored against elements of the database.

Preferably, a remote management system 200 is arranged to periodically contact the search system 10 (or be periodically contacted by the search system 10) to enable entries in the repository to be synchronized or updated.

In a preferred embodiment of the present invention, the remote management system 200 updates the search menu options of the search system 10 with the most used search providers used by a number of managed search systems 10. These options can be ranked by usage.

Queries can be submitted to different search providers depending on the type of search being performed. For example, News searches may be sent to Google's search engine by clicking on Options->Search->Google News, or Encyclopedia search can be sent to Wikipedia by clicking on Options->Search->Wikipedia.

The database of predictive text/auto-text entries could be updated from the remote management system 200. Alternatively or in addition, updates could be propagated from other users in a peer-to-peer architecture, from a community based resource or from multiple sources. Similarly, the websites, search terms or actions associated with entries could also be periodically updated in this manner.

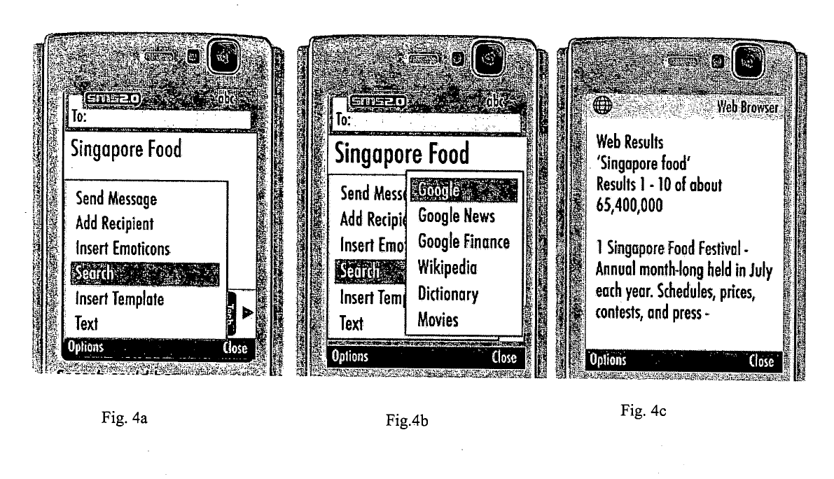

FIG. 4a-c are screen shots illustrating aspects of the web search system of FIGS. 1-3 in operation.

The web search system may be a stand-alone application or a component (integrated or plug-in) of a short messaging service (SMS) application, text editor or the like.

In a preferred embodiment of the present invention, search menu options in a messaging application may be used to execute a search query. The user can customize these search menu options if they have their own preferred search provider or a server can periodically modify them.

In a preferred embodiment of the present invention, a predictive text/autotext system is populated with text entries linked to search websites, associated functions or the like.

For example, the predictive text system may recognize the word “dinner” or a stem of the word when entered and it may highlight this and offer a link to appropriate restaurant review sites. The predictive text system may offer its own custom menu options that link to online searches or new stories. The word “map” could also be highlighted and linked to online maps. Additionally, contextual information surrounding the word can be incorporated into the search queries located in the context menu. For example, if the user types “map 90210” into their messaging application, the map word will be highlighted as normal, but the “map” context menu will also have an option to get a map for the 90210 area code rather than link to a generic mapping site.

Phone numbers and email addresses recognized by the predictive text/autotext system can also be enhanced with user generated content links. For example, a phone number already has the following action menu items associated with it: call, add to contacts, send sms, etc. In an embodiment of the present invention, options including “add to profile” can be included to store common search terms based on keywords. Embodiments of the present invention allows for the linking of online content to auto-found keywords. These auto-found keywords can also encompass brand' names or be sponsored by companies.

The predetermined search websites and other interactive websites may be updated via a central server or database in dependence on user feedback or community based feedback.

1. A web search system comprising an interface and a control subsystem, the interface having a primary non-web browsing function and being arranged to accept entry of text, wherein the control subsystem is configured to trigger on demand so as to submit at least a portion of said entered text to a predetermined web search engine, the search system being arranged to display results from the web search engine.

2. A web search system as claimed in claim 1, further comprising a repository arranged to store text entries, the control subsystem being arranged to present suggested one of said text entries in dependence on said text entered.

3. A web search system as claimed in claim 2, wherein said repository is arranged to store web search terms associated with said text entries, the control subsystem being arranged to present suggested web search terms in dependence on said text entered.

4. A web search system according to claim 3, wherein said repository is arranged to associate a predetermined web search engine with each web search term, wherein the control subsystem is arranged to submit said web search term to its associated web search engine upon being triggered.

5. A web search system according to claim 2, wherein the control subsystem is arranged to update said repository from a remote source.

6. A web search system according to claim 1, wherein the primary non-web browsing function is a short messaging service application.

7. A web search system according to claim 1, wherein the control subsystem comprises a menu of predetermined web search engines or other interactive websites.

8. A network comprising a management system and a plurality of web search systems:
the management system including a data repository comprising a plurality of predictive text entries and associated web search terms, wherein the management system is arranged to communicate with a plurality of client devices for updating the data repository in dependence on said communication;
each web search system comprising an interface and a control subsystem, the interface having a primary non-web browsing function and being arranged to accept entry of text, wherein the control subsystem is arranged to store at least a subset of the predictive text entries and associated web search terms and is arranged to present a suggested predictive text entry in dependence on the entered text, the control subsystem being configured to trigger on demand so as to submit said associated web search term to a predetermined web search engine and the search system being arranged to display results from the web search engine.

9. A network as claimed in claim 8, wherein each web search system is arranged to synchronise its stored predictive text entries with those of the management system.

10. A network as claimed in claim 8, wherein each web search system is arranged to obtain updates to its stored predictive text entries from the management system.

11. A network as claimed in claim 8, wherein each of the web search systems includes a database of predetermined web search engines, the management system being arranged to maintain a database of web search engines in the data repository and synchronise said repository with said web search systems.

12. A network as claimed in claim 11, wherein the management system is arranged to associate web search engines with said predictive text entries, wherein each of the web search systems is arranged to use said associated web search engine as the predetermined web search engine.

13. A plug-in for a computer application having a primary non-browsing function, the plug-in comprising an interface plug-in and a control subsystem wherein:
the interface plug-in comprising computer program code for cooperating with an existing interface of the application and for obtaining entered text;
the control subsystem comprising computer program code for receiving said text from said interface plug-in and for receiving a trigger to submit said associated web search term to a predetermined web search engine, the interface plug-in further comprising computer program code for displaying results from the web search engine in said existing interface of the application.

14. A method for providing a web search comprising:
interfacing with an application having a primary non-web browsing function that is arranged to accept entry of text;
triggering on demand the submission of at least a portion of said entered text to a predetermined web search engine; and
displaying results from the web search engine in said application.

15. A method as claimed in claim 14, further comprising storing text entries and presenting a suggested one of said text entries in dependence on said text entered.

16. A method as claimed in claim 15, further comprising storing web search terms associated with said text entries and presenting suggested web search terms in dependence on said text entered.

17. A method according to claim 16, further comprising associating a predetermined web search engine with each web search term and submitting said web search term to its associated web search engine activation of the triggering step.

18. A computer readable medium encoded with a computer program, the computer program comprising:
computer program code for interfacing with an application having a primary non-web browsing function that is arranged to accept entry of text;
computer program code for triggering on demand the submission of at least a portion of said entered text to a predetermined web search engine; and
computer program code for displaying results from the web search engine in said application.

19. A computer readable medium as claimed in claim 18, further comprising computer program code for storing text entries and presenting a suggested one of said text entries in dependence on said text entered.

20. A computer readable medium as claimed in claim 18, further comprising computer program code for storing web search terms associated with said text entries and presenting suggested web search terms in dependence on said text entered.
